(19) United States
(12) Patent Application Publication
(10) Pub. No.: US 2008/0036621 A1
(43) Pub. Date: Feb. 14, 2008

(54) Method for Transmitting Measuring Values Between Two Measuring Transducers

(76) Inventors: Ole Koudal, Baden (CH); Oliver Popp, Fislisbach (CH); Oliver Seifert, Bad Sackingen (CH); Ralf Uehlin, Grenzach-Wyhlen (DE); Walter Borst, Fachingen (DE)

Correspondence Address: BACON & THOMAS, PLLC, 625 SLATERS LANE, FOURTH FLOOR, ALEXANDRIA, VA, 22314, US

(21) Appl. No.: 10/578,555

(22) PCT Filed: Nov. 4, 2004
(86) PCT No.: PCT/EP04/12478

§ 371 Date: Mar. 5, 2007

(30) Foreign Application Priority Data
Nov. 6, 2003 (DE) 103 52 307.3

(51) Int. Cl. G08C 19/00

(52) U.S. Cl. 340/870.11

(57) ABSTRACT

A method for transmitting measured values between two measurement transmitters, which transmit, via two communication connections, digital signals according to the master/slave principle and analog signals to a control system, which serves as the master, comprises the steps of: transmitting the digital signals between the two measurement transmitters via an additional communication connection; and the incoming digital signals in the receiver measurement transmitter are examined for at least one characteristic value of the transmitting measurement transmitter, in order to find measured values needed for evaluation in the receiver measurement transmitter.

The invention relates to a method for transmitting measured values between two measurement transmitters, as such method is defined in the preamble of claim 1.

Used in many instances in process automation technology are measurement transmitters, which serve for registering and/or influencing process variables. Examples of such measurement transmitters are fill level measuring devices, flow measuring devices, pressure- and temperature-measuring devices, pH-redox-potential measuring devices, conductivity measuring devices, etc., which, as sensors register the corresponding process variables fill level, flow, pressure, temperature, pH and conductivity.

A number of such measurement transmitters are manufactured and sold by the firm, Endress+Hauser®.

Frequently, the measurement transmitters are connected via a communication connection with a superordinated unit, e.g. a control system or unit (PLC). An example for such a communication connection is the HART®-standard. With the help of this standard, measurement transmitters can transmit data both in digital and in analog form, to a control system. Moreover, in this way, measurement transmitters can, with the help of a corresponding operating unit, be very easily parametered and placed in operation. The measured values are transmitted in analog form to the control system using the known 4-20 mA technology. Since the HART-communication works on the basis of the master-slave principle, the measurement transmitters can transmit data to the control system only following a request by the master.

In certain circumstances, also desired is a data transmission between a number of measurement transmitters and a control system. Such a data exchange is possible e.g. in the HART-Multi-Drop operation. A disadvantage, in such case, is that each measurement transmitter connected to a HART-Multi-Drop network and having an address different from zero must possess a constant electrical current consumption of 4 mA. An analog signal transmission to the control system is not possible in HART-Multi-Drop operation.

In some applications, measured variables derived from measured values of different measurement transmitters must be determined and then processed further. A possibility for this is to transmit the measured values to the control system and run evaluation programs provided there for the further processing of the measured values. This method has, however, various disadvantages. On the one hand, the reprogramming of control systems is very complex. Furthermore, the evaluation programs in the computer are very application-specific and require know-how, which is only available to the manufacturer of the measurement transmitter and only hesitatingly divulged. Moreover, control systems are designed for control tasks and are not suited for application-specific measured-value evaluation. Integrating such application-specific functionalities into control system equipment would mean a considerable extra expense for the manufacturers of control systems.

Another possibility for the determining and further processing of measured variables derived from measured values of different measurement transmitters is to transmit the measured values to a flow computer (e.g. RMS621 of the firm Endress+Hauser Wetzer) and process further in the flow computer. The further-processed data are then transmitted from the flow computer to the control system. The deciding disadvantages in this are that, to do this, another unit is required in the processing chain and that the measured values are typically transmitted via analog interfaces, a factor which can lead to losses in accuracy.

An object of the present invention is, therefore, to provide a method for the transmission of measured values between two measurement transmitters, which method does not exhibit the aforementioned disadvantages, besides being easily and cost-favorably executable.

This object is achieved by the method defined in claim 1.

Advantageous further developments of the invention are set-forth in the dependent claims.

An essential idea of the invention is that, for two measurement transmitters, which transmit digital signals according to the master-slave principle and analog signals via two communication connections to a control system as master, an additional communication connection is provided for transmission of the digital signals between the two communication connections, with the receiving measurement transmitter examining the incoming signals according to at least one characteristic value of the transmitting measurement transmitter, in order to find only the required measured variable.

In a further development of the invention, the communication between the measurement transmitters and the control system occurs according to the HART®-standard. In this way, the measurement transmitters can communicate with the control system both in analog fashion as well as digitally and can, additionally, exchange data digitally with each other according to the HART-standard.

The characteristic value can be a units-characterizing number, which is established in the HART-standard. Each units-characterizing number characterizes a measured value on the basis of a certain unit (e.g. pressure, temperature, etc.).

In order that the transmitting measurement transmitter transmits its measured values in regular intervals to the receiving measurement transmitter, the transmitting measurement transmitter is placed in the HART® burst-mode. In this mode, a measurement transmitter can, even as slave, transmit its measured values independently of a request of a master.

In an alternative embodiment, the receiving measurement transmitter is operated in the master mode, for cyclically reading-out the measured values of the transmitting measurement transmitter.

For determining a derived, measured variable, a computing unit is installed in the receiving measurement transmitter.

In a special embodiment of the invention, the receiving measurement transmitter is a vortex measuring device and the transmitting measurement transmitter is a pressure measuring device, with the evaluating program determining from the flow rate and the pressure a derived measured variable, e.g. the mass flow value, volume flow value at standard conditions, or heat flux value.

The invention will now be explained in greater detail on the basis of an example of an embodiment shown in the drawing, the sole FIGURE of which shows as follows:

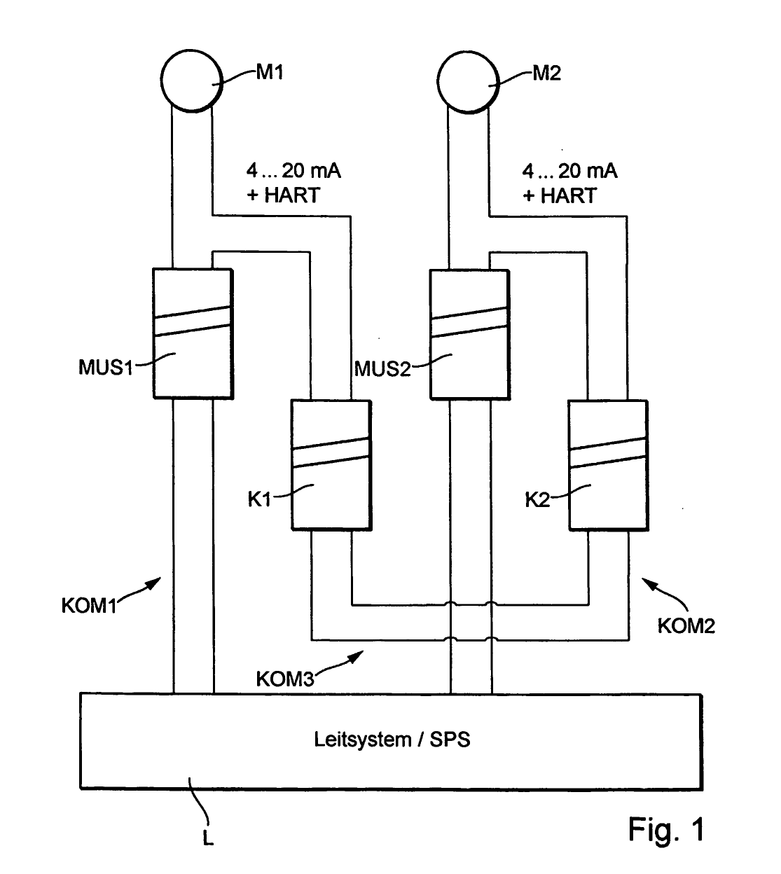

FIG. 1 in schematic representation, two measurement transmitters connected with a control system.

FIG. 1 shows schematically how two measurement transmitters M1, M2 of process automation technology are connected with a control system L via two communication connections KOM1, KOM2. Voltage (power) supply of the two measurement transmitters occurs via two measurement transmitter feeding devices MUS1 and MUS2, which are integrated into the respective communication connections KOM1, KOM2. The communication connections KOM1, KOM2 involve two-wire connections to the respective measurement transmitters M1, M2. Provided within the communication connections KOM1, KOM2 is a communication connection KOM3, via which the digital signals can be exchanged between the two communication connections KOM1, KOM2. For Ex-safety reasons, two HART couplers K1, K2 are provided in the communication connection KOM3, which, in each case, effect a galvanic separation in the communication connection KOM3. Shown in dashed lines is the communication path for transmission of measured values between the two measurement transmitters M1, M2. Data transmission occurs directly via the communication connection KOM3 and not via the control system L.

The control system serves, essentially, for fulfilling control tasks. Communication between the control system L and the measurement transmitter M1 occurs either via the 4-20 mA current loop or via digital HART signals. Measurement transmitter M1 can be a pressure measurement transmitter. Measurement transmitter M2 is e.g. a vortex measuring device, Prowirl 73, of the firm Endress+Hauser®.

The method of the invention will now be explained in greater detail. Via the communication connection KOM3, digital signals can be transmitted from the measurement transmitter M1 to the measurement transmitter M2. In order to accomplish this, only a slight re-programming of the measurement transmitter M2 is necessary. For the measurement transmitter M1, any pressure measuring device with a HART interface can be used. Since the control system L does not participate in this data exchange, changes in the control system programming are not necessary. This is of great importance.

In order to find the desired measured value and to be able to process it, the receiver measuring device M2 examines the signals incoming from the transmitting measurement transmitter for at least one characteristic value of the measurement transmitter M1. The measured value belonging to this characteristic value is then further processed in the measurement transmitter M2. The required pressure measured value is recognized via the units characterizing number, as established in the HART standard.

In order that the measurement transmitter M1 transmits its measured values to the measurement transmitter M2, the measurement transmitter M1 is placed in the HART® burst mode using an operating device (e.g. a handheld device). In this mode, measurement transmitter M1 transmits its measured values without need for a request from the control system L. Permanently available to the measurement transmitter M2, therefore, are the current measured values of measurement transmitter M1, so that then the current, derived, measured variables can also be determined in a computer unit provided in measurement transmitter M2.

In an alternative embodiment of the invention, measurement transmitter M2 monitors, during its start-up, the communication connection K2 for incoming burst reports. If such is not happening, then measurement transmitter M2 attempts to place measurement transmitter M1 into burst mode. If this is successful, then the above-described method for data transmission can be performed.

In a further, alternative embodiment of the invention, measurement transmitter M2 is operated in the master mode. In this mode, the master M2 cyclically reads-out the measured values of measurement transmitter M1. This mode permits, however, only one other master, e.g. the control system L. In this case, an operating unit can no longer be attached for the parametering of the measurement transmitter M1, or M2, as the case may be, since an operating unit must always function as master.

An essential advantage of the invention is that a specific measurement transmitter M2 can be used with different measurement transmitters M1, which come from different manufacturers, in order to determine a certain, dependent, measured variable from the measured values of these two measurement transmitters. A further aspect of the invention is that no changes in the programming need to be effected at the control system L. A further aspect of the invention is that measured values of the measurement transmitter M1 are transmitted digitally to the measurement transmitter M2—without loss in accuracy by e.g. a digital-analog, and subsequent analog-digital, conversion. The control system communicates with the measurement transmitter M1 and/or M2 independently of the communication connection KOM3. Only at measurement transmitter M2 are slight software changes necessary.

With the help of the method of the invention, a simple data transmission of measured values is possible between two measurement transmitters M1 and M2.

1-17. (canceled)

18. A method for transmitting measured values between two measurement transmitters, which transmit, via two communication connections, digital signals according to the master/slave principle and analog signals to a control system, which serves as master, comprising the steps of:
transmitting digital signals between the two measurement transmitters via an additional communication connection; and examining, using the receiver measurement transmitter, incoming digital signals for at least one characteristic value of the transmitting measurement transmitter, in order to find measured values needed for evaluation in the receiver measurement transmitter.

19. The method as claimed in claim 18, wherein:
communication between the measurement transmitters and the control system occurs according to the HART®-standard.

20. The method as claimed in claim 18, wherein:
the receiver measurement transmitter evaluates the units characterizing number associated with a given numerical value; and
the meaning of the units characterizing number is established in the HART®-standard.

21. The method as claimed in claim 18, wherein:
the transmitting measurement transmitter is placed in the HART® burst mode, for transmitting its measured values in regular intervals.

22. The method as claimed in claim 18, wherein:
the receiver measurement transmitter is operated in master mode and reads the measured values out of the transmitting measurement transmitter.

23. The method as claimed in claim 18, wherein:
the receiver measurement transmitter and the transmitting measurement transmitter register different measured variables.

24. The method as claimed in claim 23, wherein:
the receiver measurement transmitter, a computer unit is installed with an evaluation program, which determines from the different measured variables a derived measurement variable.

25. The method as claimed in claim 23, wherein:
the receiver measurement transmitter is a vortex measuring device and the transmitting measurement transmitter is a pressure measuring device, which determine, respectively, flow velocity and pressure in a medium.

26. The method as claimed in claim 25, wherein:
installed in the vortex measuring device is a flow computing unit, which determines, from the pressure value and flow velocity of the medium, a derived, measured variable.

27. The method as claimed in claim 25, wherein:
the vortex measuring device contains an additional, installed, temperature sensor.

28. The method as claimed in claim 27, wherein:
installed in the vortex measuring device is a flow computing unit, which determines from the flow velocity of the medium, the temperature value and the pressure, a derived, measured variable (e.g. heat flux value or mass flow value).

29. The method as claimed in claim 23, wherein:
the receiver measurement transmitter is a vortex measuring device with an installed, additional, temperature sensor, and the transmitting measurement transmitter is a temperature measuring device.

30. The method as claimed in claim 29, wherein:
in the measuring device, a flow computing unit is installed, which determines from the flow velocity of the medium, the temperature value of the temperature sensor of the vortex measuring device and the temperature value of the temperature measuring device, a derived, measured variable (e.g. energy drain).

31. The method as claimed in claim 23, wherein:
the receiver measurement transmitter is a vortex measuring device and the transmitting measurement transmitter is a temperature measuring device, which determine, respectively, flow velocity and temperature in a medium.

32. The method as claimed in claim 31, wherein:
in the vortex measuring device, a flow computing unit is installed, which determines from the flow velocity of the medium and the temperature, a derived, measured variable (e.g. heat flux value or mass flow value, for liquids or saturated steam).

33. The method as claimed in claim 18, wherein:
the receiver measurement transmitter accepts and evaluates signals from more than one transmitting measurement transmitter.

34. The method as claimed in claim 25, wherein:
the receiver measurement transmitter is a Coriolis flow measuring device, an ultrasonic flow measuring device or a magneto-inductively or thermally working, flow measuring device.
